(19) United States
(12) Patent Application Publication
(10) Pub. No.: US 2009/0100046 A1
(43) Pub. Date: Apr. 16, 2009

(54) Methods and Apparatus for Collecting, Searching, and Aggregating Historical Events in an Online System

(76) Inventor: Mark Mallen Huck, Seattle, WA (US)

Correspondence Address: MARK M. HUCK, 912 2ND AVE. W., SEATTLE, WA, 98119, US

(21) Appl. No.: 12/249,949

(22) Filed: Oct. 12, 2008

Related U.S. Application Data
(60) Provisional application No. 60/980,211, filed on Oct. 16, 2007.

(51) Int. Cl. G06F 17/30

(52) U.S. Cl. 707/5; 707/E17.108

(57) ABSTRACT

Systems and methods for aggregating, processing, and displaying historical data—including actions and ideas—are provided. Based on a singular endpoint event or range of endpoint events, a plurality of historical threads both forward and backward looking in time are computed and displayed to the user via an interface in a manner that can assist the user in determining the relative importance of events along a thread. Event objects are created from data aggregated from cameras, global positioning software, social networking sites, direct user input, news feeds, and other sources. Connections between the objects are based on historical attributes including actors, descriptions, places, and time.

### BACKGROUND OF THE INVENTION

1. Field of the Invention

This invention relates to Class 706 (DATA PROCESSING: ARTIFICIAL INTELLIGENCE), 45 (KNOWLEDGE PROCESSING SYSTEM), 59 (CREATION OR MODIFICATION), 60 (EXPERT SYSTEM OR SHELL).

2. Description

Today, traditional news gathering requires many layers of judgment by the news gathering organizations. These layers include deciding 1] what is important to report, 2] who should present the story, 3] what the significance of the event is or may eventually become, 4] the layout of the story, and so forth. Even internet blogs today include elements of these pre-judgments. Bloggers will still select the subject of their focus, though the sheer number of bloggers ensures at least a broader coverage than traditional print and network broadcast media.

Traditional history writing shares these limitations as well, except that the historian is even further removed from events than the reporter. Some have argued that this distance provides some objectivity, but still such writing is reliant on the original discretion of reporting sources. The inherent bias of writers has been a challenge to readers since the first histories were written. Deconstructing historical records—understanding the cultural, political, and social biases of the writer—is a primary task of historians.

Recently, however, the Internet has enabled two powerful distributed processing capabilities: worldwide search and searchable content publishing. Leveraging these capabilities, the present invention shows a radical new method for collecting and disseminating news and history. Rather than the reporter or historian selecting what is meaningful, the relationship of events, people, and places in time is used to allow this meaning to emerge.

Applications are now available on the Internet as well to store and manage photos, videos, social networks, and other content owned by end-users. However, prior art does not show a system that aggregates these content sources into a coherent history application by allowing the end-user to annotate the content with appropriate attributes to enable the content to meaningfully appear in a history-type application as historical threads.

### SUMMARY OF THE INVENTION

By “historical object” or “event” is meant a description of some event or idea having human or non-human actors, occurring within a relatively short time interval at a specific location. An event may be active, such as a soccer game, or passive, such as an idea. The latter may be considered a “thought event”. Therefore, the minimum attributes of an historical object are a description, actor, place, start date, and duration. By “historical thread” or “history” is meant a collection of historical objects connected to each other by one or more identical or similar values for the minimum attributes. Thus, a historical thread might relate to a single person or group of people. Or, a thread might relate to a place within a specific timeframe. “Emerging history” is the collection of historical threads emerging out of a set of historical attributes, into the future, toward the past, or along any attribute collected by the system such as socio-economic measures. This collection of threads, each consisting of many historical objects, with a single end-point is also referred to as a “tree”.

The present invention shows this historical thread-building mechanism. A surprising emergent history is produced in two principle ways: the first starting from an end-point event or collection of events wherein a chain of causality is programmatically discovered once an end event is selected. Second, history can be a set of searched “memories”; that is, content is recorded real-time but compiled in a search result.

Given an end-point event or collection of historical attributes, the system queries its data store for threads where each event in the thread is connected by at least one identical or closely related historical attribute, giving greater weight to multiple close matches over a single exact match. For example, an exact match on an exact date is not particularly useful, whereas matches on a particular college within a week-long period having some people in common is highly useful. These matches are then matched recursively for a number of iterations which may be selected by the user. The result is a tree—or multi-dimensional tree, one tree extending into the past, another into the future, and still others along other attribute axes from the specified end-point—where each of the branches is a thread terminating at the selected end-point event.

Various weighting factors are applied to the resulting threads. These weighting factors may include weights based on 1] the exactness of match in any or all of historical attributes, 2] the distance in, perhaps, time from the end-point, and/or 3] reputation scores attributed to the authors of events within the threads. After applying these weights, the threads are presented back to the user in any of various data presentation forms—list, tree, heat-map, or other—with a visual or numeric indicator giving the weighted strength of the thread. A more dynamic user interface would allow the user to select any point on a thread and spawn a new set of trees from that new end-point.

News organizations will benefit greatly from the present invention, both in tracking and researching ongoing stores and in discovering emergent news. The latter occurs when, for example, the end point is confined to a place—such as a city—and current time, and all resultant threads are analyzed for their weight based on other historical attributes. In this way, the news emanates from events, rather than from any prejudices on the part of news gathering organizations. The news organizations would help to create a narrative from the emergent history, particularly where multiple threads would be important to analyze simultaneously. Thus, the current invention is an aid to news reporting and not a replacement of it. It would allow for important news to emerge to many news consuming organizations and individuals. Sudden news, such as catastrophes, would naturally not be discoverable in this way. However, news resulting from trends, such as social behavior changes, would be apparent.

The present invention further discloses methods whereby a history of ideas may be incorporated into the result by relying on keyword searches. For example, if I the event “my daughter was admitted to University of Washington”, the idea of “college admissions process in the early 21^{st} century” would be relevant to the event.

Collection and input of historical object data is critical to the success of the present invention; in fact, the input of a very large number of events is necessary. The preferred embodiment of the invention suggests four means to collect this input. First, the present invention starts by providing an easy means for the end-user to input events. While laborious, the scanning of photos and recollection of events, actors, and dates can then be uploaded into the data store of the present invention.

Second, this input may also be accomplished via more automatic means, such as cameras and recorders lined to GPS and voice recognition. The use of devices such as digital cameras and camera-phones provides a mechanism to date-time stamp photos while recording the geo-positioning of the photographer. Description and actors would require additional input by the photographer, but already it is evident that this source of event data will proliferate greatly.

Third, this input may be obtained by collecting information from social networking or other applications which already hold user's content which has the necessary historical attributes associated with each of the content items. Facebook would be a good example of this. Facebook provides an application programming interface (API) which, if the user provides the appropriate credentials, allows other applications to acquire Facebook content such as photo albums which contain description, date-time stamp, and names.

Finally, the present invention shows methods for pulling in historical events from news feeds using mechanisms such as Real Simple Syndication (RSS). These feeds would be parsed and added into the present invention's data store. The proliferation of blog-type applications will similarly, over several years, pull together disparate sources into an ever more accurate record of human activity and ideas. The proliferation of these sources will diminish the importance and influence of any single source, while calling for a mechanism to determine meaningful historical threads from within the manifold sources.

### PRIOR ART

The most relevant prior art relating to the present invention is U.S. Pat. No. 7,146,574 to Goldthwaite, et al., which makes claims relating to digital history. However, these claims differ substantially from the present invention's claims. First, in Goldthwaite's patent the user must “select a time period” and the returned results relate to “the time period of interest.” The present invention, however, has a starting point a discrete event, place, or person, and the selection of a timeframe is incidental to this discrete event. Second, in Goldthwaite's patent, when “selecting one of the events, people, places and things”, the resulting display is constrained by the “time period of interest”. In the present invention, the starting point creates multiple threads emanating forward and behind in time and these threads are only constrained by the user to the number of events to include rather than a time period. Third, Goldthwaite's patent computes emphasis based on “recency of activity, . . . frequency of activity . . . and user preferences.” The present invention, however, weights the historical threads that emanate from a discrete event based on the number of associations and connections between and among the events, people, and places in each of the threads. Finally, Goldthwaite's claims do not show how digital input devices and sources such as digital cameras, social networking sites, and other sources enable the creation of a data store than enables a historical understanding outside of a “user's digital history”.

Thus, the primary but not only difference between Goldthwaite and the present invention is Goldthwaite's reliance on defined time periods “of interest”. The present invention does not consider time periods as necessary to its claims. Relationships are established by virtue of family connections, place locations, and event or idea characteristics. Time is incidental to these relationships though, of course, all human events occur within the time dimension.

In Patent Application 2006/0039030 to Peterschmidt, the claims are generally around a relational database of contextual data arranged in “contextual tables.” This application is attempting to claim standard relational database concepts. The claims are so broad that they generally cover database storage assumptions in any system developed in the last quarter century.

### OBJECTS AND ADVANTAGES

Not only can causality be computed leading up to a specific event, a series of events or collection of people can be selected as the endpoint, and causality computed. This causality analysis can be applied regionally and globally so that “top stories” are truly newsworthy. The often arbitrary selection of stories in news media will give way to computed causality.

Over time, history may become the story of how the individual arrived at her present. School history projects show students their own roots and engage them directly. Students, then, will see their activities as contributing to this story-line. History will not be “out there” but rather intimately connected to the individual.

Social networking sites can utilize and be utilized by the present invention. These sites are heavily focused on immediate communication between members. However, by supplying a triggering action that allows the user to capture only user-defined significant events, the noise of social networking can be diminished and a history can be captured. Alternately, the manifold comments of users can be parsed for historical event attributes in order to be incorporated into or become a historical object.

Accordingly, the objects and advantages of the present invention are to:
(a) provide a method and apparatus which shows a way to record events and then retrieve and display historical threads, starting either with a discrete end-event or a collection of end-events, and showing the relative importance of each thread.
(b) provide a method and apparatus for aggregating event and idea data sources.
(c) provide a method and apparatus by which the end-user incorporates the history of ideas into the threads.
(d) provide a method and apparatus for displaying relevant context in connection with discrete historical threads; that is, for showing events occurring within a larger context, whether geographic or socioeconomic, in conjunction with a particular thread.

Further objects and advantages are to make causal relationships between historical facts apparent to users as well as to provide an initial framework for research papers and other analyses. Still further objects and advantages will become apparent from a consideration of the ensuing description and drawings.

### BRIEF DESCRIPTION OF THE DRAWINGS

A typical embodiment of this invention is shown in drawing FIGS. 1 and 2.

FIG. 1 shows methods in networked computer system for collecting and annotating historical events, as well as searching and displaying historical threads.

FIG. 2 shows an extension of the methods of FIG. 1 for including the development of ideas in the historical thread.

The figures should not be considered to limit the scope of the invention, and are shown to represent a typical embodiment of the invention claims.

### DETAILED DESCRIPTION OF THE PREFERRED EMBODIMENTS

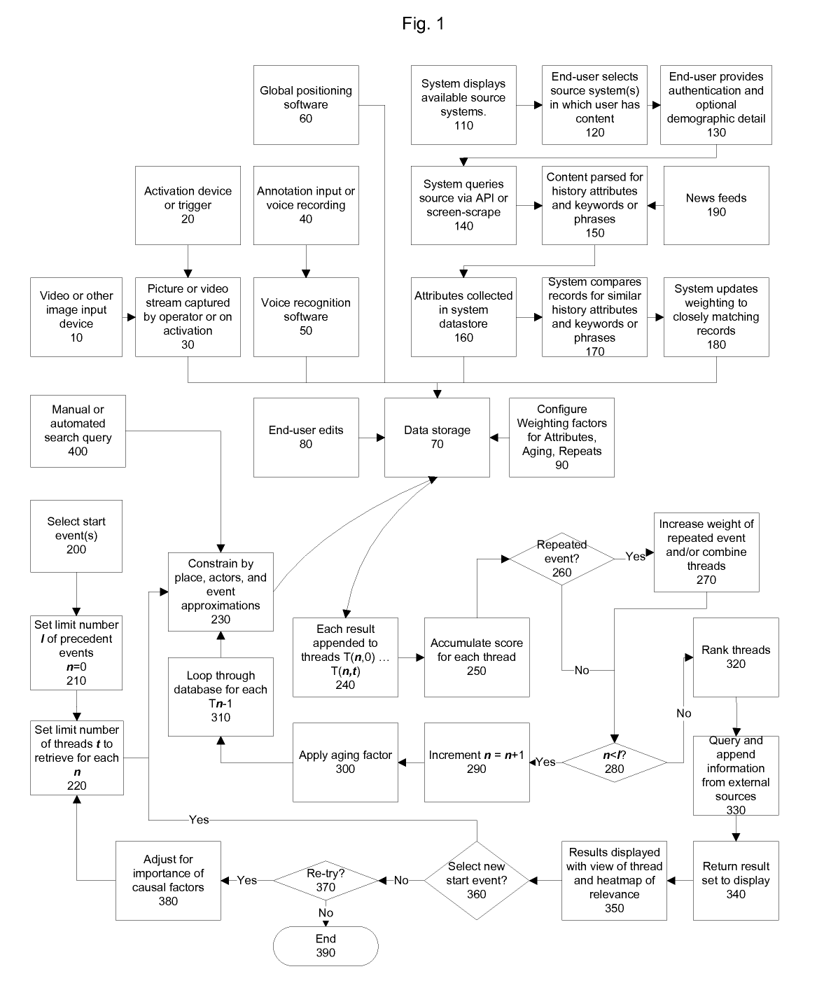

### Description of FIG. 1

A video camera, camera phone, or other image capture device (10) is triggered by an activation device (20), such as a pulse-monitoring device, to capture an image (30) to which a unique ID is attached and sent to data storage (70). Using a voice recorder or other message input device such as a telephone (40), the end-user annotates the image. Voice recognition software (50), if necessary, translates the message into text which is then associated with the image unique UI and stored in the database (70) as well, and may be edited by the end-user (80). Global positioning software (60) also captures information about place, associates this with the unique ID and stores the information in the data store (70). A date-time stamp is given to the new records in the datastore (70), and end-user ID is associated as well.

Historical events also enter the system through data imported from social networking and photo sharing sites. The system displays available sites to the user (110), and the user can then select the systems from which to cull information (120) and provide authentication information (130) as well as other demographic detail such as age, socio-economic status, etc., which aid social history. Users may also add details about people and places at this point or later. The system then uses an application programming interface (API) or screen scrape to enter the selected systems and retrieve information (140), including photos text and any metadata associated with those. The retrieved content is parsed by the system for historical attributes such as people, dates, places, and for content such as words, phrases, and full descriptions (120) which are then stored (160) in the system database (70). During or after the new records are added to the system, the system searches for related records (170) in the system and updates weighting for the records (180) for later use in determining the scope of a historical thread. News feeds (190) also feed the system in a similar fashion.

The end-user or other end-user may configure various weighting factors for eventual queries on the data (90), including weighting for each attribute of an event, the aging of an event relative to its successor event, and predecessor events repeated in historical threads.

The end-user or any other end-user may select a start event or multiple start events (200) and specify the number of preceding events (210) and total historical threads (220) to constrain the result set. A query that compares the current event attributes with events having similar attributes (230) is sent to the database (70). The results are appended to the thread spawning the query (240) and an accumulated score for each thread calculated (250) and stored temporarily. If there is an event that has already appeared in a previous thread (260), the additional weight specified (90) is applied to this event and reflected in the accumulated score (270). Optionally, the threads may be connected at this event (270). If the number of events in each thread is below the limit (280), the events are incremented (290), an aging factor applied (300), and the loop iterated again (310).

Once the limit for events is reached (220), the threads are ordered (320). Additional information from external sources can be added to the results set (330) which is then returned to the UI (340) and presented as a heat map or other graphical means (350) to show the user the importance as calculated (250). If the user wishes to select one of the subsequent events to start a query (360), the process repeats except with this new event as the start point. Otherwise, the end-user may re-try (370) the query by adjusting the weighting factors (380), or end (390).

The end-user may also initiate a match of historical threads via a search query (400) which requires the user to constrain the search (390) and then the mechanism described above ensues.

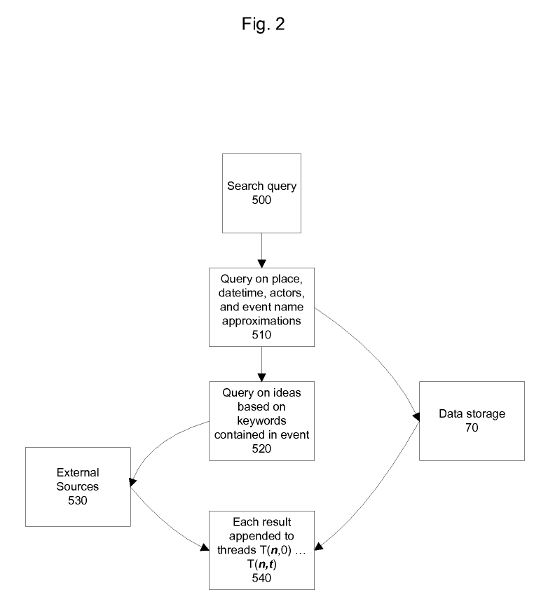

### Description of FIG. 2

A search query (500) not only queries (510) the internal data storage (70, also shown in FIG. 1) of events but also queries (520) external sources (530) based on keywords in the search or events returned in the thread and these ideas then become the basis of additional threads (540).

### CONCLUSIONS, RAMIFICATIONS, AND SCOPE

Accordingly, the reader will see that this invention provides highly functional methods for providing the operator a means for both capturing historical information via video and other media as well as to identify important historical threads leading up to any specified event or collection of historical attributes.

Although the description above contains many specificities, these should not be construed as limiting the scope of the invention but as merely providing illustrations of some of the presently preferred embodiments of this invention.

Thus, the scope of the invention should be determined by the appended claims and their legal equivalents, rather than by the examples given.

What is claimed is:

1. A method for storing, reading, and displaying unique event and idea objects, each object having the minimum attributes of unique object identifier, at least one place name or identifier, at least one individual or group actor name or identifier, at least one event or idea description, and event or idea origination date, and optionally having attributes event duration and one or more related digital images; wherein said method records data comprising of the user's identification information together with a stream of one or more images and geographical information at the same or approximately same time, such that said data may be aggregated with other data from the same or other users; whereby a subsequent user or system query specifying a set of attribute value ranges will return a collection of threads of connected objects, each object in a thread determined by matching one or more or its attribute values with those attribute values of its parent object or, in the case of the topmost object, the original query, while excluding any objects already contained in said collection.

2. The method of claim 1 wherein the data for some or all objects are received from multiple data sources which may be social networking, blog or news sites via application programming interfaces or screen-scraping programs.

3. The method of claim 1 where in the data for some or all objects are received from a character input means by user.

4. The method of claim 1 wherein the data for some objects are received from a user capturing a digital image and such image data then becoming an attribute value of an said object.

5. The method of claim 4 wherein the geographical location of the user is recorded simultaneously with the capture of the digital image and such geographical location data then becoming an attribute value or values of said object.

6. The method of claim 1 wherein said results are displayed such that the end-user may select any of the event objects and that event object's attributes are the parameters of a new query that is executed in the manner of claim 1.

7. The method of claim 1 wherein a weighting of the results based either or both of the relevance to the original query or the preponderance of a particular attribute value is shown in either graphical or numeric form.

8. The method of claim 1 wherein the results are displayed in parallel with results using expanded place attributes of related local, city, state, region, nation, world, or other such broader defined geographical context.

9. The method of claim 1 wherein the results are displayed in a family tree format each node of which displays at least the name of the family member and contains a hypertext or image link or button such that when user clicks on said link or button both or either of slide show containing time-ordered images of said member and a new family tree with member as top parent element is displayed,

10. A computer readable medium having stored thereon a plurality of computer-executable instructions for performing the method of claim 1.

11. A computing device comprising means for performing the method of claim 1.

12. A computer readable medium in a networked computer system, at least one computing device on network having components
a. providing a memory which is able to store incoming information received over a network into said memory,
b. providing a persistent data storage which is able to store incoming information received from said memory,
c. providing a processor,
d. providing such network devices necessary to connect to a network of computers,
e. providing a display which is operatively connected to such memory,
f. providing a character input means which a human operator can use to enter information into said browser
and having a plurality of computer-executable modules for storing, reading, and displaying unique event and idea objects, each object having the minimum attributes of unique object identifier, at least one place name or identifier, at least one individual or group actor name or identifier, at least one event or idea description, and event or idea origination date, and optionally having attributes event duration and one or more related digital images; wherein said method records data comprising of the user's identification information together with a stream of one or more images and geographical information at the same or approximately same time, such that said data may be aggregated with other data from the same or other users; whereby a subsequent user or system query specifying a set of attribute value ranges will return a collection of threads of connected objects, each object in a thread determined by matching one or more or its attribute values with those attribute values of its parent object or, in the case of the topmost object, the original query, while excluding any objects already contained in said collection.

13. A computer readable medium of claim 12 wherein said components operate such that the data for some or all objects are received from multiple data sources, which may be social networking, blog or news sites, via application programming interfaces, screen-scraping programs, or user initiated character input.

14. A computer readable medium of claim 12 wherein said components operate such that the data for some objects are received from a user capturing a digital image and such image data then becoming an attribute value of an event object.

15. A computer readable medium of claim 14 wherein said components operate such that the geographical location of the user is recorded simultaneously with the capture of the digital image and such geographical location data then becoming an attribute value or values of an event object.

16. A computer readable medium of claim 12 wherein said components operate such that said results are displayed such that the end-user may select any of the event objects and that event object's attributes are the parameters of a new query that is executed in the manner of claim 12.

17. A computer readable medium of claim 12 wherein said components operate such that said results are displayed in a tree-like view where the records are connected based on the similarity of attributes between the results.

18. A computer readable medium of claim 12 wherein said components operate such that a weighting of the results based either or both of the relevance to the original query or the preponderance of a particular attribute value is displayed in either graphical or numeric form.

19. A computer readable medium of claim 12 wherein said components operate such that the results are displayed in parallel with results using expanded place attributes of local, city, state, region, nation, world, or other such broader context.

20. The method of claim 12 wherein the results are displayed in a family tree format each node of which displays at least the name of the family member and contains a hypertext or image link or button such that when user clicks on said link or button both or either of slide show containing time-ordered images of said member and a new family tree with member as top parent element is displayed,
